(19) United States
(12) Patent Application Publication
(10) Pub. No.: US 2022/0332224 A1
(43) Pub. Date: Oct. 20, 2022

(54) LOCKING DEVICE FOR WALK-IN SEAT OF VEHICLE

(71) Applicant: HYUNDAI TRANSYS INC., Seosan-si (KR)

(72) Inventors: Jung Bin LEE, Hwaseong-si (KR); Hae Dong KWAK, Hwaseong-si (KR); Gwon Hwa BOK, Hwaseong-si (KR); Cheol Hwan YOON, Hwaseong-si (KR); Jae Yong JANG, Hwaseong-si (KR); Jun Sik HWANG, Hwaseong-si (KR)

(21) Appl. No.: 17/658,675

(22) Filed: Apr. 11, 2022

(30) Foreign Application Priority Data
Apr. 16, 2021 (KR) 10-2021-0049657

(51) Int. Cl. B60N 2/235; B60N 2/10

(52) U.S. Cl. CPC B60N 2/2358; B60N 2/10

(57) ABSTRACT

Disclosed is a locking device for a walk-in seat of a vehicle, the locking device including a drive plate coupled to a connection frame interconnecting a side frame with a seatback frame and configured to move the connection frame to a walk-in position when performing walk-in operation, a pawl mounted on the connection frame and configured to lock or unlock the drive plate depending on whether the walk-in operation is performed, a locking lever mounted on the connection frame and configured to rotate the pawl in a direction of locking or unlocking the drive plate, and a pressing shaft fixed to a lower end of a seat belt buckle and laterally protruding to be coupled to the connection frame, and configured to apply a load to the pawl in a direction of locking the pawl to the drive plate due to the load applied to the seat belt buckle.

This application claims under the benefit of Korean Patent Application No. 10-2021-0049657, filed on Apr. 16, 2021, the entireties of which are hereby incorporated herein by reference.

### BACKGROUND

### (a) Technical Field

The present disclosure relates to a locking device for a walk-in seat of a vehicle, and more particularly to a locking device for a walk-in seat of a vehicle having a structure capable of increasing the depth of tooth engagement between a drive plate and a pawl due to the load applied to a seat belt buckle, thereby stably maintaining the locked state of the walk-in seat prior to a walk-in operation.

### (b) Background Art

Generally, seats mounted in the interior of a passenger vehicle are installed in one or two rows. In the case of vans and sports utility vehicles, seats are installed in three or more rows, and seats are also installed in various other arrangements depending on the vehicle.

In such vehicle seats, various mechanisms offering comfortable seating to passengers or convenience for entry and exit are employed.

Particularly, in the case of a vehicle in which three or more rows of seats are installed, passengers may open a front door and a rear door and directly access a first-row seat and a second-row seat, respectively. However, in most cases of a third-row seat, a mechanism for securing a passage for entry and exit by moving the second-row seat forwards is employed.

For example, as a second-row seat for securing a passage for entry and exit for a third-row seat, a double-folding type seat configured incline a seatback, which is folded on a seat cushion, forwards together with the seat cushion, a cushion tilt-up sliding type seat configured to slide a seatback and a seat cushion forwards with the front end of the seat cushion rotated upwards, or a tilting-walk-in type seat configured to rotate the seatback forwards so as to erect the same while tilting the seat cushion downwards is adopted.

FIG. 1 is a side view illustrating the state in which a tilting-walk-in type second-row seat is operated.

As illustrated in FIG. 1, an operation in which a seat cushion 10 of a tilting-walk-in type second-row seat is tilted downwards and an operation in which a seatback 20, which has been inclined backwards, is rotated forwards and erected are performed simultaneously, thereby easily securing a passage for entry and exit for a passenger sitting in a third-row seat.

More specifically, in a structure in which a seat cushion frame 120 is tiltably connected to a side frame 110 mounted on a seat rail 100 and a connection frame 140 interconnecting the seat cushion frame 120 with a seatback frame 130 is rotatably connected to the side frame 110, an operation of tilting the seat cushion frame 120 downwards and an operation of erecting the seatback frame 130 and the connection frame 140 while rotating the same forwards are performed so as to easily secure a passage for entry and exit for a passenger of the third-row seat.

Referring to FIG. 1, the seat cushion frame 120 is supported by the side frame 110 by being hinged thereto, and the connection frame 140 interconnecting the side frame 110 with the seatback frame 130.

The operation of tilting the seat cushion and the operation of rotating the seatback for the tilting-walk-in type second-row seat should be performed only when securing a passage for entry and exit for a third-row seat, and in normal times, for the safety of an occupant of the second-row seat, the seat cushion and the seatback should be maintained in a locked state using a separate locking device for a walk-in seat.

In other words, the operation of tilting the seat cushion and the operation of rotating the seatback are performed when the locking device for a walk-in seat is unlocked, and when locking the locking device, the seat cushion and the seatback should be maintained in a locked state, in which the seat cushion and the seatback do not move, for the safety of the occupant of the second-row seat.

FIG. 2 is a perspective view illustrating components of the conventional locking device for a walk-in seat, FIG. 3 is a side view illustrating a locked state of the conventional locking device for a walk-in seat, and FIG. 4 is a side view illustrating an unlocked state of the conventional locking device for a walk-in seat.

As illustrated in FIGS. 2 to 4, for a walk-in operation, the seat cushion frame 120 is tiltably connected to the side frame 110 mounted on the seat rail 100, and the connection frame 140 interconnecting the seat cushion frame 120 with the seatback frame 130 is rotatably connected to the side frame 110.

Particularly, between the connection frame 140 and the side frame 110, a locking device 200 of a walk-in seat is mounted.

The locking device 200 of a walk-in seat includes, as illustrated in FIG. 2, a drive plate 210 for walk-in operation, a pawl 220 configured to lock or unlock the drive plate 210, and a locking lever 230 configured to rotate the pawl 220 in a direction of locking or unlocking the drive plate 210.

The drive plate 210 has a structure in which opposite ends thereof are hinged to the side frame 110 and the connection frame 140, respectively, and a sector gear 212 is formed on one side thereof.

The pawl 220 has an upper end hinged to the connection frame 140 at a predetermined position thereof. In addition, the pawl 220 is formed, at one side of a lower end thereof, with a locking gear 222, which is meshed with the sector gear 212, and, at another side of the lower end thereof, with a locking protrusion 224, an unlocking groove 226, and an unlocking protrusion 228, which are sequentially formed from below.

The locking lever 230 includes a body 232 hinged to the connection frame 140, a locking portion 234 protruding from one side of the body 232 so as to push the locking protrusion 224 towards the sector gear 212 when the locking device for a walk-in seat is locked or so as to be inserted into the unlocking groove 226 while pushing the unlocking protrusion 228 when the locking device for a walk-in seat is unlocked, and a cable connector 236 protruding from another side of the body 232 and connected to a walk-in operation lever (not shown) via a cable 238.

Here, locking and unlocking operations of the conventional locking device for a walk-in seat described above are as follows.

FIG. 5 is an enlarged view of a main portion of the conventional locking device for a walk-in seat illustrating the locked state thereof, and FIGS. 6 and 7 are enlarged views of the main portion of the conventional locking device for a walk-in seat illustrating the unlocked state thereof.

Referring to FIG. 5, when the locking portion 234 of the locking lever 230 is arranged at a position for pushing the locking protrusion 224 of the pawl 220, the locking gear 222 of the pawl 220 is meshed with the sector gear 212 of the drive plate 210 so as to restrain the drive plate 210 from moving, and as such, the drive plate 210 may be maintained in a fixed state in which the drive plate 210 does not move by being placed at a walk-in inoperative position.

On the other hand, when the cable 238 is pulled because a user operates the walk-in operation lever (not shown) for the walk-in operation, the cable connector 236 is pulled by the cable so as to rotate the locking lever 230, as illustrated in FIG. 6. Here, when the locking portion 234 is inserted into the unlocking groove 226 of the pawl 220, the locking portion 234 pushes the unlocking protrusion 228 so as to rotate the pawl 220 in an unlocking direction.

Subsequently, since the pawl 220 is rotated in the unlocking direction, the locking gear 222 of the pawl 220 is separated from the sector gear 212 of the drive plate 210.

Accordingly, as illustrated in FIG. 7, the drive plate 210 is rotated to a walk-in operative position, that is, a position in which the seatback frame 130 and the connection frame 140 are erected while being rotated forwards by the elastic restoring force of a coil spring 214.

However, the conventional locking device for a walk-in seat has the following problems.

As illustrated in FIG. 1, a buckle 240 configured to fasten a seat belt is mounted on the connection frame 140. In this structure, since a load is applied every time a tongue of the seat belt is fastened to the buckle 240, a torsional load is applied to the connection frame 140, thereby causing deformation.

Particularly, when the connection frame 140 is deformed by the torsional load, the pawl 220 is unexpectedly rotated in the unlocking direction, so that the locking gear 222 of the pawl 220 is separated from the sector gear 212 of the drive plate 210, and as such, the locking device for a walk-in seat is undesirably unlocked.

In addition, when the locking device for a walk-in seat is undesirably unlocked as described above, a safety problem may occur for passengers seated in the second row, and even if the locking device for a walk-in seat is locked again, unlocking of the locking device is easily and inevitably repeated.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention has been made in an effort to solve the above-described problems associated with the prior art, and it is an object of the present invention to provide a locking device for a walk-in seat of a vehicle having a structure capable of stably maintaining the locked state of the walk-in seat even if a connection frame of the seat, to which a seat belt buckle is connected, is deformed due to application of a torsional load thereto, thereby preventing unexpected unlocking of the walk-in seat.

In one aspect, the present invention provides a locking device for a walk-in seat of a vehicle, the locking device including a drive plate coupled to a connection frame interconnecting a side frame, which supports a seat cushion frame, with a seatback frame and configured to move the connection frame to a walk-in position when performing a walk-in operation of the seat, a pawl mounted on the connection frame and configured to lock the drive plate at a position prior to the walk-in operation of the seat or to unlock the drive plate when the walk-in operation is performed, a locking lever mounted on the connection frame and configured to rotate the pawl in a direction of locking or unlocking the drive plate, and a pressing shaft, which is fixed to a lower end of a seat belt buckle and coupled to the connection frame while laterally protruding therefrom, and which is configured to apply a load to the pawl in a direction of locking the pawl to the drive plate by the load applied to the seat belt buckle.

In a preferred embodiment, the connection frame may have formed therein a slot, and the pressing shaft may be coupled to the connection frame by being passed through the slot so that, when a load is applied to the seat belt buckle, the pressing shaft may move along the slot so as to apply the load to the pawl in the direction of locking the pawl.

In another preferred embodiment, the pawl may be formed with a load-acting portion having a protruding shape so as to be caught by the pressing shaft while the pressing shaft moves along the slot, and the pressing shaft may press the load-acting portion so as to rotate the pawl in the direction of locking the pawl to the drive plate.

In still another preferred embodiment, the pawl may have a locking gear, which is formed at a lower side of a hinged portion, the hinged portion hinged to the connection frame, and which is configured to mesh with the sector gear of the drive plate so as to lock the drive plate, and a load-acting portion formed at an upper side of the hinged portion and protruding to extend upwards.

In yet another preferred embodiment, the slot formed in the connection frame may be elongated in a vertical direction.

In still yet another preferred embodiment, the locking device may further include a buckle link having a first end rotatably hinged to the connection frame and a second end coupled to the pressing shaft, and the slot may have a shape following a movement trajectory of the second end when the buckle link rotates about the first end.

Other aspects and preferred embodiments of the invention are discussed infra.

It is to be understood that the term “vehicle” or “vehicular” or other similar term as used herein is inclusive of motor vehicles in general, such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, for example, a vehicle powered by both gasoline and electricity.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a side view illustrating the state in which a tilting-walk-in type second-row seat is operated;

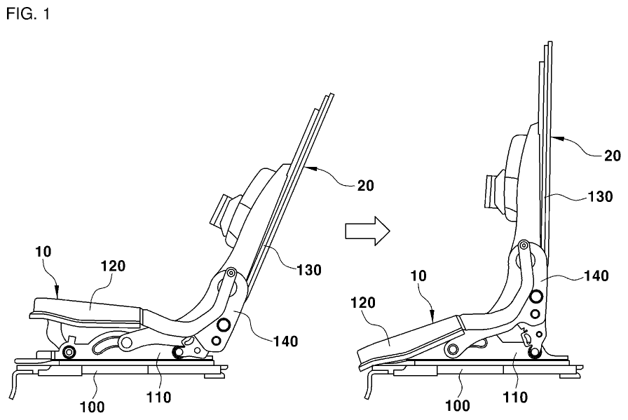

FIG. 2 is a perspective view illustrating components of a conventional locking device for a walk-in seat;

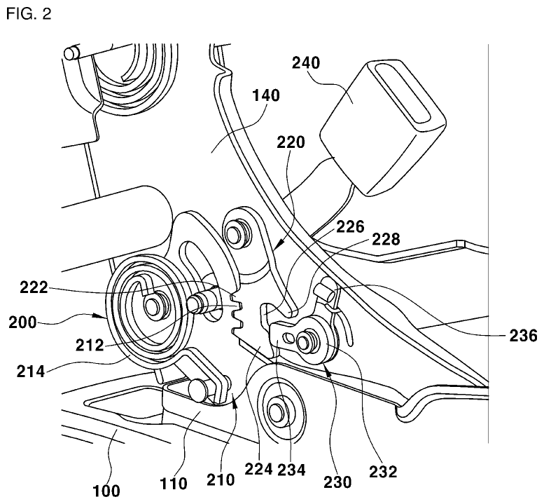

FIG. 3 is a side view illustrating a locked state of a conventional locking device for a walk-in seat;

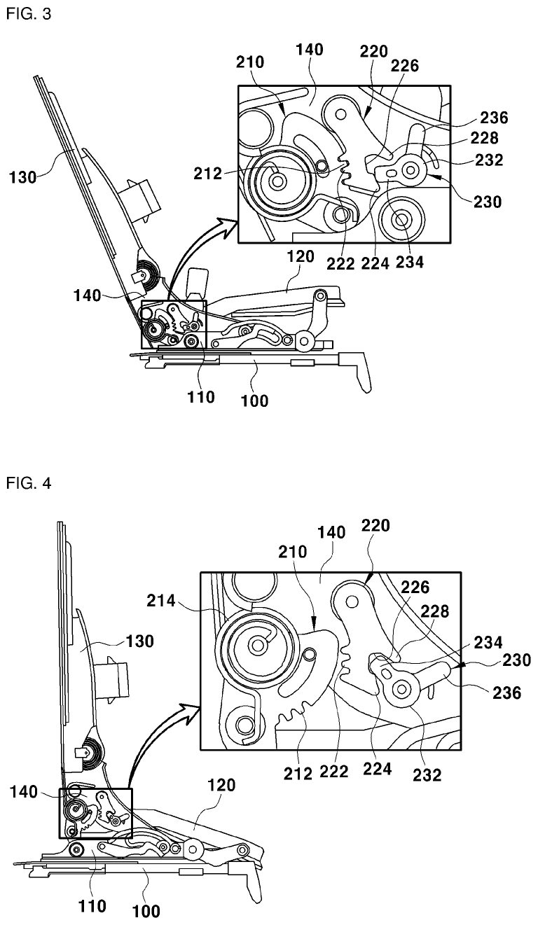

FIG. 4 is a side view illustrating an unlocked state of a conventional locking device for a walk-in seat;

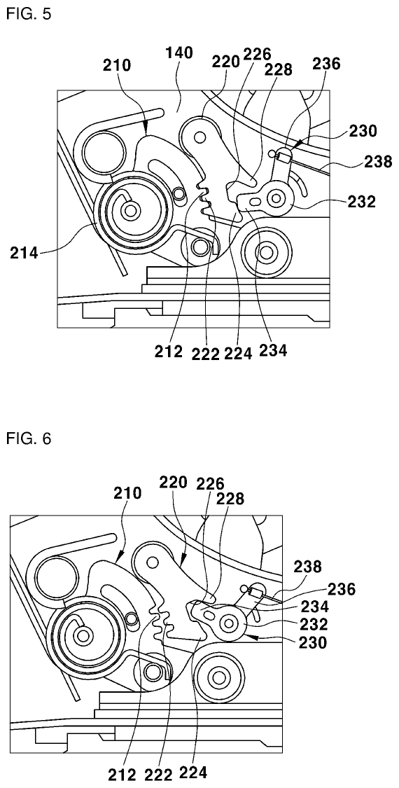

FIG. 5 is an enlarged view of a main portion of a conventional locking device for a walk-in seat illustrating a locked state thereof;

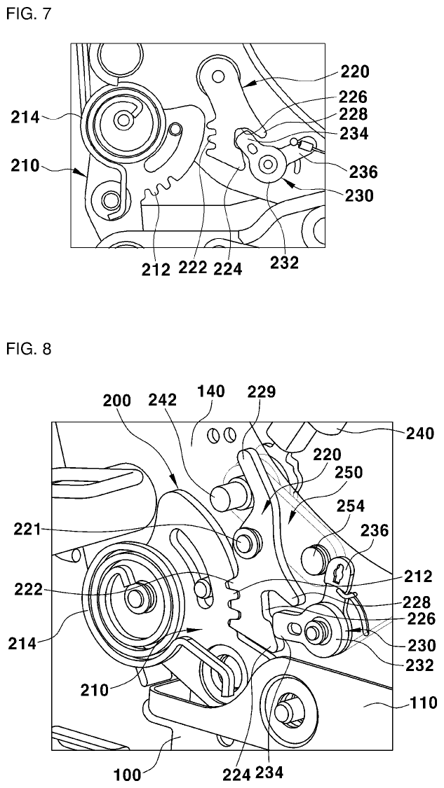

FIGS. 6 and 7 are enlarged views of a main portion of a conventional locking device for a walk-in seat illustrating an unlocking operation thereof;

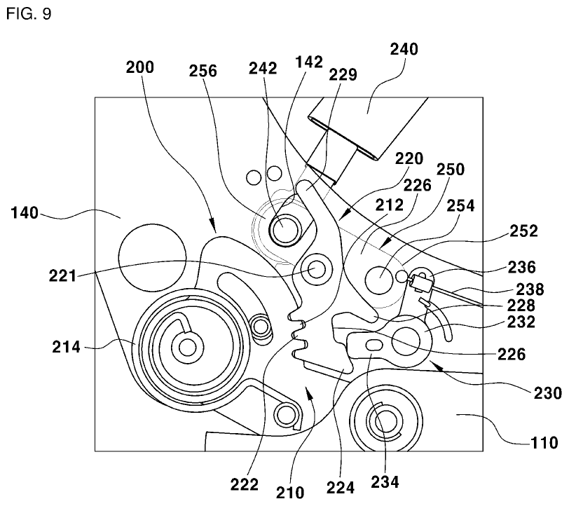

FIG. 8 is a perspective view illustrating components of a locking device for a walk-in seat according to an embodiment of the present invention;

FIGS. 9 and 10 are operation state views explaining a locked state and an unlocked state of a locking device according to an embodiment of the present invention; and

FIGS. 11 and 12 are views illustrating the state when a load is applied through a buckle in a locking device for a walk-in seat of a vehicle according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes, will be determined in part by the particular intended application and use environment.

In the figures, reference numbers refer to the same or equivalent parts of the present invention throughout the several figures of the drawing.

### DETAILED DESCRIPTION

Hereinafter, a preferred embodiment of the present invention will be described with reference to the accompanying drawings.

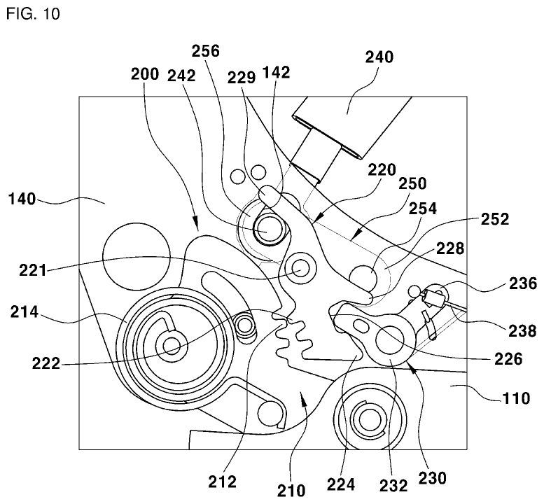

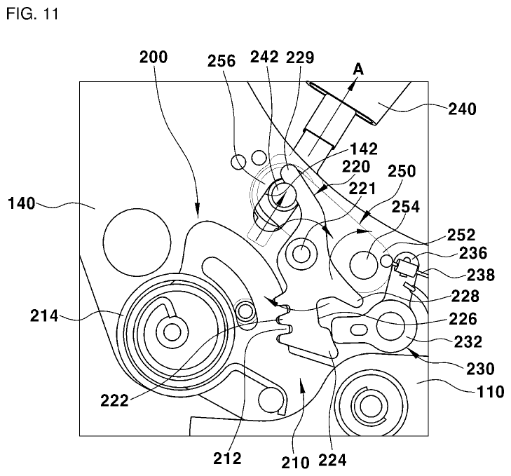

FIG. 8 is a perspective view illustrating a locking device for a walk-in seat according to an embodiment of the present invention, and FIGS. 9 and 10 are views explaining a locked state and an unlocked state of the locking device according to an embodiment of the present invention.

In the walk-in seat to which the locking device according to an embodiment of the present invention is applied, there is no difference from the above described known walk-in seat in that the seat cushion frame is tiltably connected to the side frame mounted on the seat rail, the connection frame interconnecting the seat cushion frame with the seatback frame is rotatably connected to the side frame, the connection frame interconnecting the side frame with the seatback frame, and an operation in which the seat cushion frame is tilted downwards and an operation in which the seatback frame and the connection frame are erected while rotating forwards are performed.

The locking device 200 for a walk-in seat according to an embodiment of the present invention, as illustrated in FIG. 8, includes a drive plate 210 configured to perform a walk-in operation of the seat, a pawl 220 configured to lock or unlock the drive plate 210, and a locking lever 230 configured to rotate the pawl 220 in a direction of locking or unlocking the drive plate 210.

Among the components of the locking device 200 described above, the drive plate 210 has opposite ends hinged to a side frame 110 and a connection frame 140, respectively. In addition, the drive plate 210 has one side formed with a sector gear 212.

When performing the walk-in operation of the seat, the drive plate 210 rotates upwards from the side frame 110, and moves the connection frame 140 to a walk-in position.

The pawl 220 is hinged to the connection frame 140 at a predetermined position on the connection frame 140. In addition, the pawl 220 has, at one side of a lower end thereof, a locking gear 222 meshed with the sector gear 212 of the drive plate 210, and has, at another side of the lower end thereof, a locking protrusion 224, an unlocking groove 226, and an unlocking protrusion 228, which are sequentially formed from below.

The locking lever 230 includes a body 232 hinged to the connection frame 140, a locking portion 234 protruding from one side of the body 232 so as to push the locking protrusion 224 of the pawl 220 towards the sector gear 212 when the locking device 200 is locked or so as to be inserted into the unlocking groove 226 while pushing the unlocking protrusion 228 when the locking device for a walk-in seat is unlocked, and a cable connector 236 protruding from another side of the body 232 and connected to a walk-in operation lever (not shown) via a cable 238.

Meanwhile, a seat belt buckle 240 is mounted on the connection frame 140 of the walk-in seat. The buckle 240 is a part of the seat belt device into which a tongue (not shown) coupled to the end of a seat belt webbing is inserted and fastened.

In the structure in which the buckle 240 is mounted on the connection frame 140, the buckle 240 has a lower end coupled to the outer surface of the connection frame 140. Here, the lower end of the buckle 240 has a pressing shaft 242 fixed to the connection frame 140.

The pressing shaft 242 is provided to pass through the connection frame 140. To achieve this structure, the connection frame 140 has formed therein an elongated slot 142, and the pressing shaft 242 is inserted through the slot 142 so as to be movable along the slot 142.

In such a structure in which the pressing shaft 242 passes through the slot 142 in the connection frame 140, the pressing shaft 242 has one end coupled to the lower end of the buckle 240 from the outer side of the connection frame 140, and has another end, which is opposite the one end, arranged to extend and protrude laterally from the inner side of the connection frame 140.

In addition, the connection frame 140 has, at the outer surface thereof, a buckle link 250, which is provided at the lower side of the buckle 240 and is elongated in an inclined direction. Here, a first end 252 of the buckle link 250 (the lower end of the buckle link in the drawing) on the outer side of the connection frame 140 is hinged to the connection frame 140 via a fastener 254.

In addition, a second end 256 of the buckle link 250 (the upper end of the buckle link in the drawing) on the outer side of the connection frame 140 is coupled to the pressing shaft 242, which passes through the slot 142 in the connection frame 140.

Here, the pressing shaft 242 may be coupled to the second end 256 of the buckle link 250 in the structure in which the pressing shaft 242 penetrates the second end 256. The second end 256 of the buckle link 250 may be rotatably coupled to the outer circumferential surface of the pressing shaft 242 from the outer side of the connection frame 140.

The slot 142 is formed to be elongated in a downwardly oblique direction in the connection frame 140, and more specifically, the slot 142 is formed to have a predetermined length in a shape that follows the movement trajectory of the second end 256 of the buckle link 250 when the buckle link 250 is rotated about the first end 252 and the fastener 254.

Here, the pressing shaft 242 is fixedly coupled to the lower end of the buckle 240 from the outer side of the connection frame 140 in the state of being coupled by passing through the slot 142 in the connection frame 140, and is arranged to extend and protrude laterally from the inner side of the connection frame 140.

In this structure, the position of the pressing shaft 242 is a position where the lower end of the buckle 240 is coupled to the connection frame 140, which is a mounting point at which the buckle 240 is mounted on the connection frame 140.

In addition, since the lower end of the buckle 240, the pressing shaft 242, and the first end 252 of the buckle link 250 are portions that are movable along the slot, the fastener 254, which hinges the second end 256 of the buckle link 250 to the connection frame 140, is a buckle hinge point in the connection frame 140.

Moreover, in an embodiment of the present invention, the pawl 220 is formed, at the upper portion thereof, with the load-acting portion 229, and the load-acting portion 229 has a shape extending upwards from the upper side of the hinged portion 221, which is the rotation center of the pawl 220 and is coupled to the connection frame 140.

In the pawl 220, the load-acting portion 229 is formed to be caught when the pressing shaft 242 moves upwards along the slot 142 in the connection frame 140. The load-acting portion 229 is a portion provided such that when an upward load is applied to the buckle 240, the load-acting portion 229 may come into contact with and press the pressing shaft 242 while the pressing shaft 242 moves upwards along the slot 142.

In this way, when the pressing shaft 242 pushes the load-acting portion 229, which is the upper end of the pawl 220, upwards or applies force thereto, the force is applied to the pawl 220 by the pressing shaft 242 so as to rotate the locking gear 222 in a direction of meshing the locking gear 222 with the sector gear 212 of the drive plate 210.

As a result, in the locking device 200 according to the present invention, when an upward pulling load is applied to the buckle 240, even if the frame is deformed by the buckle 240 due to the torsional load applied to the frame inside the seat such as connection frame 140, the pressing shaft 242 coupled to the lower end of the buckle 240 moves along the slot 142 in the connection frame 140 so as to push the load-acting portion 229 of the pawl 220 upwards, and accordingly, the load is applied to the pawl 220 in a direction in which the locking gear 222 is more deeply meshed with the sector gear 212 of the drive plate 210.

Accordingly, the depth of tooth engagement and locking force between the pawl 220 and the drive plate 210 may be increased, and the locked state of the walk-in seat may be stably maintained.

On the other hand, in the conventional locking device, when a load is applied to the buckle, the pawl receives force in a direction in which the locking gear is separated from the sector gear of the drive plate by the load applied to the buckle. Here, since the locking gear of the pawl is actually separated from the sector gear of the drive plate, the locked state of the seat may be released.

The configuration of the locking device according to the embodiment of the present invention has been described above. Hereinafter, the operating state of the locking device according to the embodiment of the present invention will be described.

FIG. 9 illustrates a locked state of the locking device according to an embodiment of the present invention, and FIG. 10 illustrates an unlocked state of the same.

As illustrated in FIG. 9, in the locked state, the locking gear 222 of the pawl 220 is meshed with the sector gear 212 of the drive plate 210, and the locking portion 234 of the locking lever 230 supports the locking protrusion 224 of the pawl 220 while pressing the same.

Accordingly, the pawl 220 is locked and incapable of being rotated by the locking lever 230. Here, the locking gear 222 of the pawl 220 maintains a state in which the locking gear 222 is meshed with the sector gear 212 of the drive plate 210, that is, the locked state.

In such a locked state, when a user operates the walk-in operation lever as illustrated in FIG. 10, the cable connector 236 is pulled by the cable 238 and the locking lever 230 is rotated in an unlocking direction (the clockwise direction in the drawing).

Here, when the locking portion 234 of the rotating locking lever 230 is inserted into the unlocking groove 226 of the pawl 220, the locking portion 234 pushes the unlocking protrusion 228 so as to rotate the pawl 220 in the unlocking direction.

In other words, the pawl 220 is rotated in the counterclockwise direction in the drawing about the hinged portion 221, which is hinged to the connection frame 140. At this time, the locking gear 222 formed at the lower side of the hinged portion 221 in the pawl 220 is lifted and separated from the sector gear 212 of the drive plate 210, and ultimately the locking between the pawl 220 and the drive plate 210 is released.

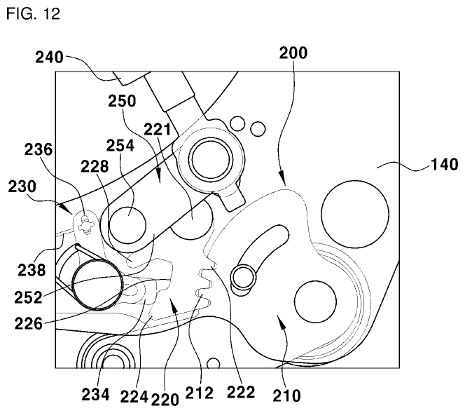

FIG. 11 is a view illustrating the state when a load is applied through the buckle 240 in the locking device 200 for a walk-in seat of a vehicle according to an embodiment of the present invention, and FIG. 12 is a view illustrating the state in FIG. 11 viewed from the outside of the connection frame 140.

Among the components of the locking device illustrated in FIG. 12, the drive plate 210, the pawl 220, the locking lever 230, etc. are mounted on the inner surface of the connection frame 140, and the buckle link 250 is mounted on the outer surface of the connection frame 140.

Since the drive plate 210, the pawl 220, and the locking lever 230 are located on the inner side of the connection frame 140, the connection frame 140 covers the drive plate 210, the pawl 220, the locking lever 230, etc. However, in FIG. 12, the drive plate 210, the pawl 220, the locking lever 230, etc. are superimposed on the connection frame 140 and on the buckle link 250, etc. so as to show the installation state and operation state of each of the components of the locking device 200 in an easy-to-understand manner.

First, when a load is applied to the buckle 240 in an upward direction, that is, the ‘A’ direction in FIG. 11, a buckle-mounting point on the connection frame 140 and the pressing shaft 242 positioned at the buckle-mounting point move upwards along the slot 142 in the connection frame 140 so as to come into contact with the load-acting portion 229 formed on the upper side of the pawl 220.

Here, the buckle link 250 is rotated upwards (the clockwise direction in the drawing) about the first end 252 hinged to the connection frame 140 via the fastener 254, and the second end 256 of the buckle link 250 moves upwards along the slot 142 together with the pressing shaft 242.

Accordingly, the pressing shaft 242 pushes the load-acting portion 229 of the pawl 220 upwards, and the pressing shaft 242 applies a load through the load-acting portion 229 of the pawl 220 in a direction of locking the drive plate 210 to the pawl 220.

In other words, since the pressing shaft 242 pushes the load-acting portion 229 upwards, the pawl 220 rotates about the hinged portion 221, which is hinged to the connection frame 140, in the clockwise direction in the drawing. Here, the direction in which the pawl 220 rotates is the direction in which the depth of engagement between the locking gear 222 of the pawl 220 and the sector gear 212 of the drive plate 210 is increased.

As a result, even when the load from the seat belt buckle 240 is applied, the locking gear 222 is rotated in a direction in which the locking gear 222 is more deeply meshed with the sector gear 212 of the drive plate 210, thereby increasing the depth of tooth engagement and locking force between the drive plate 210 and pawl 220 and stably maintaining the locked state of the walk-in seat.

Therefore, according to the locking device of the present invention, even if the connection frame 140 of the seat, to which the seat belt buckle 240 is connected, is deformed due to application of a torsional load thereto, unexpected release of the locked state of the walk-in seat may be effectively prevented.

As is apparent from the above description, the present invention provides the following effects.

According to an embodiment of the present invention, a locking device for a walk-in seat has a structure in which a pressing shaft is provided at the lower end of a seat belt buckle, and a load-acting portion pressed by the pressing shaft is formed at the upper end of a pawl so as to allow the pressing shaft to press the load-acting portion when a load is applied through the seat belt buckle, and so as to allow the pawl to rotate in a direction in which a locking gear is more deeply meshed with a sector gear of a drive plate, thereby increasing the depth of tooth engagement and locking force between the drive plate and pawl and stably maintaining the locked state of the walk-in seat.

Particularly, even if the connection frame of the seat, to which the seat belt buckle is connected, is deformed due to application of a torsional load thereto, unexpected release of the locked state of the walk-in seat may be effectively prevented.

Although the present invention has been described in detail with reference to an embodiment, the scope of the present invention is not limited to the above-described embodiment, and various modifications and improvements by those skilled in the art using the basic concept of the present invention as defined in the claims below will also be included in the scope of the present invention.

What is claimed is:

1. A locking device for a walk-in seat of a vehicle, the locking device comprising:
a drive plate coupled to a connection frame interconnecting a side frame, configured to support a seat cushion frame, with a seatback frame and configured to move the connection frame to a walk-in position when performing a walk-in operation of the seat;
a pawl mounted on the connection frame and configured to lock the drive plate at a position prior to the walk-in operation of the seat or to unlock the drive plate when the walk-in operation is performed;
a locking lever mounted on the connection frame and configured to rotate the pawl in a direction of locking or unlocking the drive plate; and
a pressing shaft, fixed to a lower end of a seat belt buckle and coupled to the connection frame while laterally protruding therefrom, and configured to apply a load to the pawl in a direction of locking the pawl to the drive plate by the load applied to the seat belt buckle.

2. The locking device according to claim 1, wherein:
the connection frame has formed therein a slot, and
the pressing shaft is coupled to the connection frame by being passed through the slot so that, when a load is applied to the seat belt buckle, the pressing shaft moves along the slot so as to apply the load to the pawl in the direction of locking the pawl.

3. The locking device according to claim 2, wherein:
the pawl is formed with a load-acting portion having a protruding shape so as to be caught by the pressing shaft while the pressing shaft moves along the slot, and
the pressing shaft presses the load-acting portion so as to rotate the pawl in a direction of locking the pawl to the drive plate.

4. The locking device according to claim 3, wherein the pawl has:
a locking gear formed at a lower side of a hinged portion that is hinged to the connection frame and configured to mesh with the sector gear of the drive plate so as to lock the drive plate; and
a load-acting portion formed at an upper side of the hinged portion and protruding to extend upwards.

5. The locking device according to claim 2, wherein the slot formed in the connection frame is elongated in a vertical direction.

6. The locking device according to claim 2, further comprising a buckle link having a first end rotatably hinged to the connection frame and a second end coupled to the pressing shaft,
wherein the slot has a shape following a movement trajectory of the second end when the buckle link rotates about the first end.
